(19) United States
(12) Patent Application Publication
(10) Pub. No.: US 2017/0275450 A1
(43) Pub. Date: Sep. 28, 2017

(54) ACRYLIC BLOCK COPOLYMER ADHESIVES

(71) Applicant: 3M INNOVATIVE PROPERTIES COMPANY, St. Paul, MN (US)

(72) Inventors: Michael D. Determan, Mahtomedi, MN (US); Kiu-Yuen Tse, Woodbury, MN (US); Joon Chatterjee, Bloomington, MN (US)

(21) Appl. No.: 15/510,715

(22) PCT Filed: Sep. 16, 2015
(86) PCT No.: PCT/US2015/050356

§ 371 Date: Mar. 13, 2017

Related U.S. Application Data
(60) Provisional application No. 62/052,673, filed on Sep. 19, 2014.

(51) Int. Cl. A61K 51/08; C08L 53/00; C09J 153/00

(52) U.S. Cl. CPC C08L 53/00; C09J 153/00

(57) ABSTRACT

Adhesive compositions and articles containing the adhesive compositions are provided. In some embodiments, the adhesive compositions can be positioned adjacent to biological surfaces such as skin. For example, articles are provided that can be used in wound dressing or that can be used to stabilize and/or affix a medical device or medical instrument to a patient.

### CROSS REFERENCE TO RELATED APPLICATION

This application claims the benefit of U.S. Provisional Patent Application No. 62/052673, filed Sep. 19, 2014, the disclosure of which is incorporated by reference herein in its entirety.

### TECHNICAL FIELD

The disclosure relates to an adhesive that includes an acrylic block copolymer composition and to an article that includes the adhesive.

### BACKGROUND

Adhesives have many commercial applications. Block copolymers have been used in adhesives such as those described, for example, in U.S. Pat. No. 6,723,407 (Dollase et al.), U.S. Pat. No. 5,711,940 (Kuentz), U.S. Pat. No. 6,734,256 (Everaerts et al.), and U.S. Pat. No. 7,255,920 (Everaerts et al.).

U.S. Patent Application Publication 2013/0079468 (Kanemura et al.) describes a pressure-sensitive adhesive composition that is suitable for optical film. This adhesive contains “a specific acrylic diblock copolymer (I) and a specific acrylic triblock copolymer (II) in a specific proportion.” The mass ratio of the acrylic diblock copolymer (I) to the acrylic triblock copolymer (II) is in the range of 70/30 to 30/70. The adhesive “exhibits durability by virtue of rise of adhesive strength when the optical film is kept in the applied state over a long period of time after application.”

While a variety of adhesives are known, not all adhesives are suitable for applications that require adhesion to biological surfaces such as skin.

### SUMMARY

Adhesive compositions and articles containing the adhesive compositions are provided. In some embodiments, the adhesive compositions can be positioned adjacent to biological surfaces such as skin. For example, articles are provided that can be used in wound dressing or that can be used to stabilize and/or affix a medical device or medical instrument to a patient.

In a first aspect, an adhesive is provided that can comprise:
(a) an acrylic triblock copolymer A-B-A comprising from 20% to 55% by weight A blocks and 45% to 80% by weight B block; and
(b) an acrylic diblock copolymer A-B comprising from 5% to 30% by weight A block and 70% to 95% by weight B block, wherein

each A block is independently a polymeric block having a glass transition temperature of at least 50° C.;

each A block independently comprises at least one poly(meth)acrylate;

each B block is independently a polymeric block having a glass transition temperature no greater than 20° C.;

each B block independently comprises at least one poly(meth)acrylate; and

the weight ratio of the acrylic diblock copolymer to the acrylic triblock copolymer is from 65:35 to 90:10.

In a second aspect, an article is provided that comprises a substrate and an adhesive layer positioned adjacent to the substrate. The adhesive layer contains the adhesive described above.

In a third aspect, a wound dressing is provided that comprises an adhesive as described above.

In a fourth aspect, a method of using the adhesive is provided that includes affixing or stabilizing a medical device to a patient using with an adhesive as described above.

### DETAILED DESCRIPTION

Adhesive compositions and articles containing the adhesive compositions are provided. In some embodiments, the adhesive compositions can be positioned adjacent to biological surfaces such as skin. For example, articles are provided that can be used in wound dressing or that can be used to stabilize and/or affix a medical device or medical instrument to a patient.

Throughout the disclosure, singular forms such as “a,” “an,” and “the” are often used for convenience. However, it is to be understood that such singular forms include the plural unless the singular alone is either specified or clearly called for by context.

“Copolymer” and conjugations (variations) thereof each refer to a polymer having more than one type of repeating unit.

“Block copolymer” and conjugations thereof each refer to a linear copolymer having a plurality of segments, known as polymeric “blocks”. Each block includes multiple monomeric units and different blocks contain different types of monomeric units. The boundary between adjacent blocks can be sharp, wherein the composition of the monomeric units changes abruptly, or tapered, wherein there is a mixing region between the blocks containing monomeric units from both of the adjacent blocks. The term “block copolymer”, including both its plural and conjugate forms, may be written with standard numerical prefixes to indicate the number of blocks. Thus, “diblock copolymer” and “triblock copolymer” are block copolymers with two and three blocks, respectively. Star copolymers, graft copolymers, comb copolymers, dendrimers, and other macromolecules with substantially non-linear architectures are not block copolymers as that term is used herein.

“Da” is an abbreviation for “Dalton” or its plural, “Daltons” and is an accepted unit of molecular weight. The abbreviation Da may be modified by typical prefixes indicating orders of magnitude, for example, kDa is an abbreviation for kilo Dalton. “Homopolymer” and its conjugations thereof each refer to a polymer or a block of a block copolymer that is composed substantially of a single polymerized monomer. As used in this context, being composed substantially of a single polymerized monomer means that no more than incidental or trace amounts of other monomers, such as impurities, can be present.

“(Meth)acrylate” and conjugations thereof each refer to esters of (meth)acrylic acid. (Meth)acrylates are often alkyl (meth)acrylate, aryl (meth)acrylates, or aralkyl (meth)acrylates.

“(Meth)acrylic acid” and conjugations thereof each refer to one or more of methacrylic acid and acrylic acid.

“Alkyl” refers to a saturated monovalent hydrocarbon radical. Alkyl radicals can be linear, branched, cyclic, or a combination thereof (e.g., an alkyl radical can have a cyclic portion and a linear or branched portion). Alkyl radicals can have any suitable number of carbon atoms. For example, alkyl radicals can be from C₁ to C₂₂. Some alkyl radicals are C₁ or greater, C₂ or greater, C₃ or greater, C₄ or greater, C₆ or greater, or C₈ or greater. Some alkyl radicals are C₂₂ or smaller, C₂₀ or smaller, C₁₈ or smaller, C₁₆ or smaller, C₁₂ or smaller, Cio or smaller, C₉ or smaller, C₈ or smaller, C₆ or smaller, or C₄ or smaller.

“Aryl” refers to a cyclic aromatic monovalent hydrocarbon radical. Aryl radicals can have any suitable number of carbon atoms. Some aryl radicals are C₆ or higher, C₁₀ or higher, or C₁₄ or higher. Some aryl radicals are C₁₆ or smaller, C₁₄ or smaller, or Cio or smaller. Phenyl is a common aryl radical.

“Aralkyl” refers to a monovalent radical having an aryl component covalently bound to an alkyl component. Aralkyl radicals are bound to a molecule, monomer, or polymer; the bond can be by way of an aryl carbon or an alkyl carbon. The aryl portion of an aralkyl radical can have any suitable number of carbon atoms, such as those referred to above with respect to the definition of aryl. Likewise, the alkyl portion of an aralkyl radical can have any suitable number of carbon atoms, such as those referred to above with respect to the definition of alkyl.

“Chemical crosslinker” and conjugations thereof each refer to a chemical compound that has multiple reactive sites for forming covalent bonds with one or more existing or growing polymer chains. Chemical crosslinkers typically have two, three, or more ethylenically unsaturated groups. Monomers such as (meth)acrylates that have only one ethylenically unsaturated group are not chemical crosslinkers, even though such monomers can form crosslinked polymers by way of, for example, chain transfer reactions.

“Acrylic polymer” including conjugations thereof each refer to a polymer or block made up of a polymerized product of one or more of monomers having a (meth)acryloyl group, which is a group of formula H₂C═CR—(CO)— where R is hydrogen or methyl and refers to a methacryloyl, an acryloyl group, or both. Suitable monomers include, for example, (meth)acrylic acid, (meth)acrylate, (meth)acrylamide, N-alkyl (meth)acrlyamide, N-dialkyl (meth)acrylamide, N-trialkyl (meth)acrylamide, and hydroxy substituted alkyl (meth)acrylate. Acrylic polymers can also contain polymerized or partially polymerized forms of one or more chemical crosslinkers. Only incidental or trace amounts of other materials, such as impurities, are present in the chemical structure of acrylic polymers.

“Acrylic block copolymer” including conjugations thereof each refer to block copolymers wherein each polymeric block is an acrylic polymer. A numerical prefix may be used to identify the number of blocks, thus “acrylic diblock copolymers” and “acrylic triblock copolymers” have two and three blocks, respectively. No other types of polymeric blocks, such as styrene blocks, olefinic blocks, or vinyl ester blocks, are present in acrylic block copolymers.

The prefix “poly” before the name of a monomer refers to a polymer or polymer block that is predominantly made up of a polymerized version of the specified monomer. In this context, “predominantly made up of” means that at least 80%, at least 85%, at least 90%, at least 95%, or at least 99% of the repeat units in the polymer or polymer block are polymerized versions of the specified monomer. The remainder of the polymer or polymer block can include polymerized versions of monomers other than the specified monomer.

The terms “adhesive” and “adhesive composition” are used interchangeably.

“Independently” when used in reference to an element that appears in multiple instances means that each instance of the element can be the same or different. For example, if element E appears in two instances and can be independently X or Y, then the first and second instances of element E can be, respectively, X and X, X and Y, Y and X, or Y and Y.

“Edge lift” refers to the disjoining of an article, such as an adhesive article, from an adherent.

Adhesives for use in applications that require adhesion to biological surfaces such as skin can have a combination of properties that can be unacceptable for other applications. Adhesives to be used on the skin can have low shear to allow easy removal of the adhered article. However, for use in many applications, adhesives should also have sufficient tack to adhere an article to skin without significant edge lift for a sufficient period of time (e.g., 1 day to 2 weeks or more). Furthermore, adhesives for use on the skin or other biological surface should not leave unacceptable levels of residue on the skin or biological surface after being removed. Thus, one technical problem to be solved is to formulate an adhesive for use on skin that has improved properties in these regards. However, it is to be understood that the adhesive composition, articles containing the same, and methods of using the same, may also address or solve other technical problems. Thus, the scope of protection sought is not to be limited by this technical problem.

The above problem can be solved by using an adhesive having a particular acrylic triblock copolymer and a particular acrylic diblock copolymer in a particular ratio. In particular, such adhesive can comprise:
(a) an acrylic triblock copolymer A-B-A comprising from 20% to 55% by weight A blocks and 45% to 80% by weight B block; and
(b) an acrylic diblock copolymer A-B comprising from 5% to 30% by weight A block and 70% to 95% by weight B block, wherein

each A block is independently a polymeric block having a glass transition temperature of at least 50° C.;

each A block independently comprises at least one poly(meth)acrylate;

each B block is independently a polymeric block having a glass transition temperature no greater than 20° C.;

each B block independently comprises at least one poly(meth)acrylate; and

the weight ratio of the acrylic diblock copolymer to the acrylic triblock copolymer is from 65:35 to 90:10.

Further, an adhesive article comprising such a composition and methods of using the same are also solutions to this problem.

Various unexpected effects and advantages can be obtained by way of these solutions. One such effect is that the resulting adhesive compositions can have excellent adhesion to skin over a sufficient period of time while being removable without leaving an unacceptable amount of residue on the skin. Also, the resulting adhesive compositions can have low shear holding time when measured on stainless steel. That an adhesive composition can have this combination of properties is surprising, because low shear holding time is typically associated with adhesives that have low cohesive strength, whereas a low amount of residuals is typically associated with adhesives that have high cohesive strength.

The adhesive compositions can be adhered to the skin without significant edge lift for a period of one day to 2 weeks or more. Depending on the application, this period of time can be one day or more, two days or more, three days or more, four days or more, five days or more, six days or more, or seven days or more. For some applications, the period of time is two weeks or less, thirteen days or less, twelve days or less, eleven days or less, ten days or less, nine days or less, or seven days or less. For some applications, the period of time is one week.

The adhesive compositions can be useful for adhering articles, such as bandages, wound dressings, medical devices or instruments, and the like, to biological surfaces such as skin, as well as to other surfaces. Stated differently, various adhesive-containing articles are provided that include the adhesive compositions such as, for example, bandages, wound dressings, adhesive tape, and the like. Such adhered articles can be readily removed, for example, because of the low shear of the adhesive.

An adhesive composition can comprise an acrylic triblock copolymer A-B-A and an acrylic diblock copolymer A-B. Each A can be, independently, a polymer block having a glass transition temperature of at least 50° C. and, independently, can comprise at least one poly(meth)acrylate. Each B can be, independently, a polymeric block having a glass transition temperature no greater than 20° C. and, independently, can comprise at least one poly(meth)acrylate.

The glass transition temperature can be determined from dynamical mechanical measurements. These measurements can be conducted using a rheometer in a shear geometry. For example, the polymeric sample can be tested in a parallel plate rheometer by heating from −50° C. to 200° C. at a rate of 2° C./minute and at a frequency of 1 radian/second. The storage modulus (G′), the loss modulus (G″), and tan δ (G″/G′) are plotted versus temperature. At very low temperatures (<−50° C.), the entire polymeric material is in a glassy state and is predominately elastic. A precipitous drop is observed in the storage modulus (G′) over a temperature range from about −50° C. to about 0° C. or from about −50° C. to about 20° C. A peak in tan δ is observed that is associated with the Tg of the B block. That is, the peak occurs at the glass transition temperature of the B block. Above about 50° C., the storage modulus drops due to the onset of polymeric flow and as the glass transition temperature of the A blocks are exceeded. A steep increase in tan δ is observed that is associated with the Tg of the A blocks. That is, the steep increase in tan δ occurs at the glass transition temperature of the A blocks.

The acrylic triblock copolymer can contain particular amounts of the A blocks and the B block. For example, the acrylic triblock copolymer (A-B-A) can have an A block content, that is, the total content of both A blocks taken together, that is from 20% to 55% by weight. In some cases, the A block content of the acrylic triblock copolymer is at least 20% by weight, at least 25% by weight, at least 30% by weight, at least 35% by weight, at least 40% by weight, or at least 50% by weight. In some cases, the A block content of the acrylic triblock copolymer is no more than 55% by weight, no more than 50% by weight, no more than 45% by weight, no more than 40% by weight, no more than 35% by weight, no more than 30% by weight, or no more than 25% by weight.

Each of the two A blocks of the acrylic triblock copolymer can be about the same weight. That is, the weight ratio of the two A blocks of the acrylic triblock copolymer is often 1:1. However, other weight ratios can also be used. In many cases, the weight ratio of the two A blocks of the acrylic triblock copolymer is no lower than 0.65:1, 0.7:1, 0.75:1, 0.8:1, 0.85:1, 0.9:1, or 0.95:1.

The B block content of the acrylic triblock copolymer can be from 45% to 80% by weight. The B block content of the acrylic triblock copolymer can be at least 45% by weight, at least 50% by weight, at least 55% by weight, at least 60% by weight, at least 65% by weight, at least 70% by weight, or at least 75% by weight. The B block content of the acrylic triblock copolymer can be no more than 80% by weight, no more than 75% by weight, no more than 70% by weight, no more than 65% by weight, no more than 60% by weight, no more than 55% by weight, or no more than 50% by weight.

The acrylic triblock copolymer can have a number average molecular weight, Mₙ, that is no less than 25 kDa, for example, no less than 30 kDa, no less than 35 kDa, no less than 40 kDa, no less than 45 kDa, or no less than 50 kDa. The acrylic triblock copolymer can have a Mₙ that is no greater than 150 kDa, for example, no greater than 140 kDa, no greater than 130 kDa, no greater than 120 kDa, no greater than 110 kDa, or no greater than 100 kDa. Thus, in some cases the Mₙ of the acrylic triblock copolymer can be from 25 kDa to 150 kDa, such as from 30 kDa to 140 kDa, from 35 kDa to 140 kDa, from 35 kDa to 130 kDa, from 40 kDa to 130 kDa, from 40 kDa to 120 kDa, or from 45 kDa to 120 kDa. The polydispersity index, PDI, of the acrylic triblock copolymer is typically 1.5 or less, such 1.3 or less, 1.2 or less or 1.1 or less, although this is not required unless otherwise specified. Thus, the weight average molecular weight, M_{w}, of the acrylic triblock copolymer can be no less than 25 kDa, such as no less than 30 kDa, no less than 35 kDa, no less than 40 kDa, no less than 50 kDa, or no less than 55 kDa. The acrylic triblock copolymer can have an M_{w} that is no greater than 160 kDa, for example, no greater than 150 kDa, no greater than 140 kDa, no greater than 130 kDa, no greater than 120 kDa, or no greater than 110 kDa. Exemplary ranges of the M_{w} of the acrylic triblock copolymer can be from 25 kDa to 160 kDa, such as from 30 kDa to 150 kDa, from 35 kDa to 150 kDa, from 40 kDa to 140 kDa, from 40 kDa to 130 kDa, from 40 kDa to 120 kDa, from 50 kDa to 140 kDa, from 50 kDa to 130 kDa, from 50 kDa to 120 kDa, from 55 kDa to 120 kDa, or from 50 kDa to 110 kDa.

The acrylic diblock copolymer can contain specific amounts of the A block and the B block. For example, the acrylic diblock copolymer can have an A block content that is from 5% to 30% by weight. In some cases, the A block content of the acrylic diblock copolymer can be no less than 5% by weight, no less than 10% by weight, no less than 15% by weight, no less than 20% by weight, or no less than 25% by weight. In some cases, the A block content of the acrylic diblock copolymer can be no greater than 30% by weight, no greater than 25% by weight, no greater than 20% by weight, no greater than 15% by weight, or no greater than 10% by weight.

The B block content of the acrylic diblock copolymer can be from 70% to 95% by weight. In some cases, the B block content of the acrylic diblock copolymer can be no less than 70% by weight, no less than 75% by weight, no less than 80% by weight, no less than 85% by weight, or no less than 90% by weight. In some cases, the B block content of the acrylic diblock copolymer can be no greater than 95% by weight, no greater than 90% by weight, no greater than 85% by weight, no greater than 80% by weight, no greater than 75% by weight, or no greater than 70% by weight.

The acrylic diblock copolymer can have a particular number average molecular weight, Mₙ, from that is no less than 25 kDa, no less than 35 kDa, no less than 40 kDa, no less than 45 kDa, or no less than 50 kDa. The Mₙ of the acrylic diblock copolymer can be no greater than 100 kDa, no greater than 85 kDa, no greater than 80 kDa, no greater than 75 kDa, no greater than 70 kDa, no greater than 65 kDa, or no greater than 60 kDa. Exemplary ranges for the Mₙ of the acrylic diblock copolymer include, but are not limited to, 25 kDa to 100 kDa, such as from 25 kDa to 90 kDa, from 25 kDa to 80 kDa, from 25 kDa to 70 kDa, from 25 kDa to 60 kDa, from 35 kDa to 90 kDa, from 35 kDa to 80 kDa, from 30 kDa to 70 kDa, from 35 kDa to 60 kDa, from 40 kDa to 90 kDa, from 40 kDa to 80 kDa, from 40 kDa to 70 kDa, or from 40 kDa to 60 kDa. The polydispersity index of the acrylic diblock copolymer is typically 1.5 or less, such 1.3 or less, 1.2 or less or 1.1 or less, although this is not required unless otherwise specified. Thus, the weight average molecular weight, M_{w}, of the acrylic diblock can be no less than 30 kDa, no less than 35 kDa, or no less than 40 kDa. Similarly, the M_{w} of the acrylic diblock can be no more than 125 kDa, no more than 100 kDa, no more than 90 kDa, or no more than 80 kDa. Exemplary ranges for M_{w} of the acrylic diblock can be from 30 kDa to 125 kDa, 30 kDa to 100 kDa, from 30 kDa to 90 kDa, from 30 kDa to 80 kDa, from 40 kDa to 125 kDa, from 40 kDa to 100 kDa, or from 40 kDa to 90 kDa.

The A blocks of the acrylic diblock copolymer, the acrylic triblock copolymer, or both the acrylic diblock copolymer and the acrylic triblock copolymer can be hard blocks in that they can have greater rigidity than that of the B blocks. Thus, the A blocks can have a higher glass transition temperature than the B blocks. The A blocks can be thermoplastic, and can provide structural strength, cohesive strength, or both, to the adhesive.

The B blocks of the acrylic diblock copolymer, the acrylic triblock copolymer, or both the acrylic diblock copolymer and the acrylic triblock copolymer can be soft blocks in that they can have greater elasticity than the A blocks. Thus, the B blocks can have lower glass transition temperatures than the A blocks. The B blocks can be elastomeric.

While a variety of polymer types can be used as the A block and the B block, in many cases the A blocks are a poly(methacrylate) such as a poly(alkyl methacarylate) and the B blocks is a poly(acrylate) such as a poly(alkyl acrylate).

One or more of the various blocks can be a homopolymer. For example, the A block of the acrylic diblock copolymer can be homopolymer. Also, one of the A blocks of the acrylic triblock copolymer can be a homopolymer, or both of the A blocks of the acrylic triblock copolymer can be homopolymeric. Further, the B block of the acrylic diblock copolymer, the acrylic triblock copolymer, or both the acrylic diblock copolymer and the acrylic triblock copolymer can be a homopolymer.

A variety of polymer blocks can be independently used as the A blocks in the acrylic diblock copolymer, the acrylic triblock copolymer, or both the acrylic diblock copolymer and the acrylic triblock copolymer in order to provide a rigid A block having a glass transition temperature of at least 50° C. In many cases, such A blocks include one or more of poly(alkyl (meth)acrylate), poly(aryl (meth)acrylate), and poly(aralkyl (meth)acrylate). Most commonly, one or more poly(alkyl (meth)acrylates) are used. The alkyl groups in the poly(alkyl (meth)acrylate) can be any suitable alkyl group that produces an A block having the requisite glass transition temperature, such as one or more of methyl, ethyl, isopropyl, tent-butyl, sec-butyl, iso-butyl, cyclohexyl, isobornyl, and 3,3,5-trimethylcyclohexyl. In some cases, C₁ to C₃ alkyl can be used. In some cases, the (meth)acrylate is a methacrylate. Typical methacrylates include poly(methyl methacrylate), poly(ethyl methacrylate), poly(n-propyl methacrylate), poly(isopropyl methacrylate), poly(n-butyl methacrylate), poly(sec-butyl methacrylate), poly(isobutyl methacrylate), poly(tert-butyl methacrylate), poly(isobornyl methacrylate), poly(n-hexyl methacrylate), poly(cyclohexyl methacrylate), poly(2-ethylhexyl methacrylate), poly(n-octyl methacrylate), poly(isobornyl (meth)acrylate), and poly(3,3,5-trimethylcyclohexyl methacrylate). Poly(methyl methacrylate) is most common, but no specific polymer is required, so long as the A block has the requisite glass transition temperature.

Stated differently, each A block can be prepared from any suitable monomer or monomer mixture provided the resulting block has a glass transition temperature of at least 50° C. The monomers used to form each A block are often selected from an alkyl methacrylate (e.g., those having an alkyl group with 1 to 10 carbon atoms or 1 to 6 carbon atoms), an aryl methacrylate (e.g., an aryl having 5 or 6 carbon atoms), or an aralkyl methacrylate (e.g., those having an aralkyl group with 7 to 12 carbon atoms or 7 to 10 carbon atoms). Example monomers include, but are not limited to, methyl methacrylate, ethyl methacrylate, propyl methacrylate, n-butyl methacrylate, sec-butyl methacrylate, isobutyl methacrylate, tent-butyl methacrylate, n-hexyl methacrylate, cyclohexyl methacrylate, 2-ethylhexyl methacrylate, n-octyl methacrylate, and 3,3,5-trimethylcyclohexyl methacrylate, isobornyl (meth)acrylate, phenyl methacrylate, and benzyl methacrylate. In many embodiments, the monomer used to form each A block is methyl methacrylate.

In some embodiments, the A block can be formed from a monomer mixture containing an alkyl methacrylate and up to 20% by weight of one or more additional acrylic monomers, such as an (meth)acrylamide, (meth)acrylic acid, or hydroxy-substituted alkyl (meth)acrylate. In such cases, the A block is typically a random copolymer that contains up to 20% by weight, up to 10% by weight, up to 5% by weight, or up to 1% by weight of the one or more additional acrylic monomers that are randomly distributed throughout the A block. For example, the A block can contain 80 to 99% by weight of an alkyl methacrylate and 1 to 20% by weight of the additional acrylic monomer or 90 to 99% by weight of an alkyl methacrylate and 1 to 10% by weight of the additional acrylic monomer. These one or more additional monomers are typically polar, and can be added to one or more of the A blocks to adjust the glass transition temperature and cohesive strength of the A blocks.

The various A blocks can be the same or different. Thus, the two A blocks in the acrylic triblock copolymer can be the same or different from each other. Further, each of the two A blocks in the acrylic triblock copolymer can be the same or different from the A block in the acrylic diblock copolymer. The two A blocks in the acrylic triblock copolymer are often the same. Also, the A blocks in the acrylic diblock copolymer are often the same as the A blocks in the acrylic triblock copolymer, however this is not required unless otherwise specified. When the two A blocks in the acrylic triblock copolymer are the same as each other or the same as the A block in the acrylic diblock copolymer, the compatibility between the various A blocks can be maximized.

The glass transition temperature of any of the A blocks is at least 50° C., however, it can also be at least 60° C., at least 80° C., at least 100° C., at least 120° C., or higher. In addition, the glass transition temperature of the A blocks is often no greater than 200° C., no greater than 190° C., or no greater than 180° C. Exemplary ranges of glass transition temperatures of the A blocks include 50° C. to 200° C., 60° C. to 200° C., 80° C. to 200° C., 80° C. to 180° C., or 100° C. to 180° C.

A variety of polymers can be independently used as B blocks in order to provide a flexible block having a glass transition temperature of no more than 20° C. Typically, such polymers comprise one or more of poly(alkyl (meth)acrylate), poly(aryl (meth)acrylate), poly(aralkyl (meth)acrylate), or poly((meth)acrylic acid). In many embodiment, the B block is a poly (alkyl (meth)acrylate). In particular, the B block is often a poly(alkyl acrylate). The alkyl group of the alkyl (meth)acrylate can be any suitable alkyl group that produces a B block having the requisite glass transition temperature. In some cases, the alkyl can be one or more C₂ to C₂₀ alkyl, for example one or more C₂ to C₁₆ alkyl, one or more C₄ to C₁₂ alkyl, one or more C₄ to C₉ alkyl, or one or more C₄ to C₈ alkyl. Typical examples include one or more of n-butyl, propyl, including any isomer thereof, hexyl, including any isomer thereof, octyl (that is, C₈ alkyl), including any isomer thereof, or nonyl (that is, C₉ alkyl), including any isomer thereof. While any octyl isomer can be used, isooctyl (i.e., 1-methylheptyl), 2-octyl, and 2-ethylhexyl are common. Bicyclo [2.2.2] octyl can also be used. While any nonyl isomer can be used, isononyl is common. Thus, the B block is often poly(n-butyl acrylate), poly(sec-butyl acrylate), poly(isobutyl acrylate), poly(n-propyl acrylate), poly(isopropyl acrylate), poly(l-methylheptyl acrylate), poly(2-ethylhexyl acrylate), poly(isooctyl acrylate), poly(2-octyl acrylate), poly(isononyl acrylate), or poly(bicyclo [2.2.2] octyl acrylate). Poly (n-butyl acrylate) is common.

Stated differently, the B block can be prepared from any suitable monomer or monomer mixture provided the resulting block has a glass transition temperature is no more than 20° C. Examples alkyl acrylates include, but are not limited to, n-butyl acrylate, decyl acrylate, 2-ethoxy ethyl acrylate, 2-ethoxy ethyl methacrylate, isoamyl acrylate, n-hexyl acrylate, n-hexyl methacrylate, isobutyl acrylate, isodecyl acrylate, isodecyl methacrylate, isononyl acrylate, 2-ethylhexyl acrylate, 2-ethylhexyl methacrylate, isooctyl acrylate, isotridecyl acrylate, lauryl acrylate, 2-methylbutyl acrylate, 4-methyl-2-pentyl acrylate, n-octyl acrylate, 2-octyl acrylate, isononyl acrylate, n-propyl acrylate, 4-methylheptyl acrylate, and bicyclo [2.2.2]octyl acrylate. Some methacrylates can be used such as isooctyl methacrylate, n-octyl methacrylate, and lauryl methacrylate. In many embodiments, the monomer used to form the B block is n-butyl acrylate.

Like the A blocks, the B block can be prepared from additional monomers such as the polar monomers that are described above. For example, the B block can be prepared from a monomer mixture that includes 80 to 99% by weight of an alkyl acrylate and 1 to 20% by weight of the additional acrylic monomer or 90 to 99% by weight of an alkyl acrylate and 1 to 10% by weight of the additional acrylic monomer.

While the B blocks in the acrylic triblock copolymer and acrylic diblock copolymer can be selected from the same group of polymerized monomers, the various B blocks can be the same or different. Thus, the B block of the acrylic diblock copolymer can be the same as or different from the B block of the acrylic triblock copolymer. In many cases, the B block of the acrylic diblock copolymer is the same as the B block of the acrylic triblock copolymer. Using B blocks of the acrylic diblock copolymer that are the same as the B blocks of the acrylic triblock copolymer can maximize the compatibility of the various B blocks.

The glass transition temperature of the B blocks is no more than 20° C., however, it can also be no more than 10° C., no more than 5° C., no more than 0° C., no more than −10° C., no more than −20° C., no more than −30° C., no more than −40° C., no more than −50° C., or no more than −75° C. Exemplary ranges for the glass transition temperature of the B blocks include −20° C. to 20° C., −20° C. to 10° C., −50° C. to 0° C., and −50° C. to 10° C.

The acrylic triblock copolymer and acrylic diblock copolymer can be synthesized by any suitable technique. Suitable techniques can include anionic polymerization, radical polymerization, group transfer polymerization, and ring-opening polymerization. The polymerization can be a “living” or “controlled/living” polymerization, which can have the advantage of producing block copolymer structures that are well defined. Specific examples include atom transfer radical polymerization (ATRP) and reversible addition-fragmentation chain transfer polymerization (RAFT).

Living polymerization techniques can lead to more stereoregular block structures than blocks prepared using non-living or pseudo-living polymerization techniques, such as polymerization reactions that use iniferters. Stereoregularity can be evidenced by highly syndiotactic or isotactic structures, and can result in well-controlled block structures. Such structures can influence the glass transition temperature of the block. For example, syndiotactic poly(methyl methacrylate) (PMMA) synthesized using living polymerization techniques can have a glass transition temperature that is as much as 20° C. to 25° C. higher than comparable atactic PMMA synthesized using non-living polymerization techniques. Thus, the glass transition temperature of the various blocks of the block copolymers can depend on the block copolymers stereoregularity as well as on the monomer content of the block copolymers. Stereoregularity can be detected, for example, using nuclear magnetic resonance spectroscopy. Structures with greater than about 75 percent stereoregularity can often be obtained using living or controlled/living polymerization techniques, such as those discussed above. No particular degree stereoregularity or tacticity is required for any of the A or B blocks in the acrylic triblock copolymers or acrylic diblock copolymers, so long as the various A blocks and B blocks have the requisite glass transition temperatures.

Living polymerizations can also provide block copolymers with sharp transitions between the blocks. Block copolymers having A blocks and B blocks can have regions on the boarder of an A block and a B block that contain a mixture of both A monomers and B monomers. When a living polymerization technique is used, the size of such regions can be minimized, or even eliminated, leading to a sharper transition from an A block to a B block, or from a B block to an A block. This can be beneficial when phase separation of A blocks and B blocks is desired, because a region of mixed A and B monomeric units can be compatible with both A and B blocks, thereby reducing the phase separation. On the other hand, a sharp transition with minimal regions of mixed A and B monomeric units can promote phase separation.

When living polymerization techniques are used to form a block, the monomers can be contacted with an initiator in the presence of an inert diluent. The inert diluent can facilitate heat transfer and mixing of the initiator with the monomers. Typically, the inert diluent is one or more molecules that do not undergo a chemical reaction under the polymerization conditions. Although any suitable inert diluent can be used, saturated hydrocarbons, aromatic hydrocarbons, ethers, esters, ketones, and combinations thereof are often selected. Exemplary inert diluents include, but are not limited to, saturated aliphatic and cycloaliphatic hydrocarbons such as hexane, octane, cyclohexane, and the like; aromatic hydrocarbons such as benzene, toluene, and xylene; and aliphatic and cyclic ethers such as dimethyl ether, diethyl ether, tetrahydrofuran, and the like; esters such as ethyl acetate, butyl acetate, and the like; and ketones such as acetone, methyl ethyl ketone, methyl isobutyl ketone, and the like.

When block copolymers are prepared using living anionic polymerization techniques, the simplified structure A-M can represent a living A block where M is an initiator fragment that is typically selected from a Group I metal such as Li, Na, or K. The A block can be the polymerization product of a first monomer composition that includes (meth)acrylate monomers, such as alkyl methacrylates (e.g., methyl (meth)acrylate). A second monomer composition that includes the monomers used to form the B block can be added to A-M resulting in the formation of the living diblock structure A-B-M. The addition of another charge of the first monomer composition and the subsequent elimination of the living anion site, for example, by quenching, can result in the formation of triblock structure A-B-A. Alternatively, living diblock A-B-M structures can be coupled using difunctional or multifunctional coupling agents to form the triblock structure A-B-A copolymers.

Any initiator known in the art for living anionic polymerization reactions can be used. Typical initiators include alkali metal hydrocarbons such as organomonolithium compounds, examples of which include ethyl lithium, n-propyl lithium, iso-propyl lithium, n-butyl lithium, sec-butyl lithium, tert-octyl lithium, n-decyl lithium, phenyl lithium, 2-naphthyl lithium, 4-butylphenyl lithium, 4-phenylbutyl lithium, cyclohexyl lithium, and the like. Such initiators can be referred to as mono functional initiators because each molecule of initiator produces one anion. Monofunctional initiators can be useful in the preparation of a living A block or a living B block. For living anionic polymerization of (meth)acrylates, the reactivity of the anion can be tempered by the addition of one or more complexing ligands such as one or more of lithium chloride, crown ethers, or lithioethoxylates.

The initiator in living anionic polymerizations is often added drop wise to the monomers until a characteristic color that is typically associated with the anion of the initiator persists. The preliminary drop wise addition can destroy contaminants that react with initiator, thereby providing better control of the polymerization reaction. Then, the calculated amount of the initiator can be added to produce a polymer of the desired molecular weight. The amount of initiator needed for any particular molecular weight of polymer can be calculated by using a known amount of monomer and assuming that each molecule of initiator will produce a single polymer chain, all of which will be of equal length. This assumption is reasonably accurate for many living anionic polymerizations.

When the block copolymers are prepared using living free radical polymerization techniques, one or more free radical initiators can be used. Free radical initiators useful for living free radical polymerizations, as well as procedures for such polymerization, are known; a detailed description can be found in International Patent Application Publication Nos. WO 97/18247 (Matyjaszewski et al.) and WO 98/01478 (Le et al.), as well as in the Handbook of Radical Polymerization (Matyjaszewski et al.).

The polymerization temperature used depends on the monomers being polymerized and on the type of polymerization technique used. In many cases, appropriate reaction temperatures for polymerization range from −100° C. to 200° C. For living anionic polymerization reactions, the appropriate temperature is often from −80° C. to 20° C. For living free radical polymerization reactions, the appropriate reaction temperature is often from 20° C. to 150° C.

The polymerization reaction can be carried out under controlled conditions so as to exclude substances that can destroy the initiator, living radical, or living anion. Typically, the polymerization reaction is carried out in an inert atmosphere such as nitrogen, argon, helium, or combinations thereof, although this is not required in all circumstances. When the reaction is a living anionic polymerization, anhydrous conditions can be used.

The adhesive composition can contain a particular ratio of diblock copolymer to triblock copolymer on a weight basis. For example, depending on the particular application, the ratio of the acrylic diblock copolymer to acrylic triblock copolymer can be from 65:35 to 80:20, from 70:30 to 90:10, from 70:30 to 80:20, from 75:25 to 90:10, or from 75:25 to 80:20.

The relative amount of the acrylic diblock copolymer and the acrylic triblock copolymer can also be expressed as a weight percent of the acrylic diblock copolymer, the acrylic triblock copolymer, or both, relative to the total weight of the acrylic diblock copolymer and the acrylic triblock copolymer. Expressed in this manner, the amount of acrylic diblock copolymer can be 65% by weight or greater, 70% by weight or greater, 80% by weight or greater, or 85% by weight or greater, relative to the total weight of the acrylic diblock copolymer and the acrylic triblock copolymer. In some cases, the amount of the acrylic diblock copolymer can be no more than 90% by weight, no more than 85% by weight, no more than 80% by weight, no more than 75% by weight, or no more than 70% by weight, relative to the total weight of the acrylic diblock copolymer and the acrylic triblock copolymer. Likewise, the amount of the acrylic triblock copolymer can be 10% by weight or greater, 15% by weight or greater, 20% by weight or greater, 25% by weight or greater, or 30% by weight or greater relative to the total weight of the acrylic diblock copolymer and the acrylic triblock copolymer. The amount of the acrylic triblock copolymer can also be no more than 35% by weight, no more than 30% by weight, no more than 25% by weight, no more than 20% by weight, or no more than 15% by weight relative to the total weight of the acrylic diblock copolymer and the acrylic triblock copolymer.

The adhesive composition is typically free of chemical crosslinkers. Nonetheless, it is possible for some covalent or chemical crosslinking to occur, particularly if the adhesive composition is treated with radiation, in particular ionizing radiation, gamma radiation, or E-beam radiation. Depending on the intended use of the adhesive composition, such treatment can be desirable or even necessary, for example, as part of a sterilization process.

The chemical identity of the various A blocks and B blocks relates to the glass transition temperatures of those blocks. In part because of the different glass transition temperatures of the A blocks and the B blocks, the A blocks can have solubility parameters that are sufficiently different from those of the B block such that an A block phase is separated from a B block phase. This phase separation can cause the adhesive composition to have a multiphase morphology at applicable temperatures, and particularly at temperatures from ambient temperature up to about 150° C. Thus, the adhesive composition can have distinct regions of hard A block domains, which can be nanodomains with sizes on the order of nanometers or tens of nanometers, in a matrix of soft B block domains. Matrices of soft B block domains that have maximum continuity can be achieved by selecting a B block of the acrylic triblock copolymer that is highly compatible with the B block of the acrylic diblock copolymer. Thus, the B block of the acrylic triblock copolymer is often selected to have the same chemical identity as the B block of the acrylic triblock copolymer.

The phase separated domains can have different morphologies depending on the relative amounts of the A and B blocks in the acrylic diblock copolymer and the acrylic triblock copolymer, as well as the ratio of the acrylic diblock copolymer to the acrylic triblock copolymer. The multiphase morphology can give rise to physical crosslinking, whereby the A blocks of the acrylic diblock copolymer associate with the A blocks of the acrylic triblock copolymer and the B blocks of the acrylic diblock copolymer associate with the B blocks of the acrylic triblock copolymer. This physical crosslinking is different from chemical crosslinking in that physical crosslinking forms crosslinks by non-covalent interactions, and not by the formation of covalent chemical bonds. The extent or strength of the physical crosslinking can be maximized by selecting A blocks of the acrylic triblock copolymer that are highly compatible both with each other and with the A block of the acrylic diblock copolymer. Thus, the A blocks of the acrylic triblock copolymer are often selected to have the same chemical identity as each other, and are also often selected to have the same chemical identity as the A block of the acrylic diblock copolymer.

In addition to relating to the chemical identity of the various A and B blocks of the acrylic triblock copolymer and the acrylic diblock copolymer, the extent of physical crosslinking and ultimate properties of the adhesive composition can also depend on the relative weights of the various A and B blocks of the acrylic triblock copolymer and the acrylic diblock copolymer. The nanodomains of the hard A block can be responsible for physical crosslinking of the adhesive composition. In particular, the two A blocks of the acrylic triblock copolymer can act as physical crosslinkers for the acrylic diblock copolymer. Higher amounts of physical crosslinking can relate to increased cohesive strength of the adhesive composition. As such, increasing the A block content of the acrylic triblock copolymer, of the acrylic diblock copolymer, or of both the acrylic triblock copolymer and the acrylic diblock copolymer tends to increase the cohesive strength of the adhesive composition. Increasing the content of the acrylic triblock copolymer tends to have the same effect. For this reason, an adhesive composition having an A block content of either the acrylic triblock copolymer or the acrylic diblock copolymer that is lower than what is described herein (or conversely, a B block content of either the acrylic diblock copolymer or the acrylic triblock copolymer that is higher than what is described herein) can have insufficient cohesive strength to be cleanly removable (low residue).

The matrix formed by the B blocks in the adhesive composition can be responsible for the tackiness of the adhesive compositions. Accordingly, an adhesive composition having a lower B block content (or conversely, a higher A block content) of the acrylic triblock copolymer, acrylic diblock copolymer, or both, than what is described herein can have insufficient tackiness to properly adhere to a substrate. The same result can occur when the amount of acrylic triblock copolymer is higher than what is described herein, because increasing the amount of physical crosslinking also tends to decrease tackiness.

When the weight ratios of the A and B blocks in the acrylic diblock copolymer or acrylic triblock copolymer are not within the specified ranges, or when the weight ratio of the acrylic diblock copolymer to the acrylic triblock copolymer are not within the specified ranges, the adhesive composition may not have the desired properties. For example, if the weight ratio of the acrylic diblock copolymer to acrylic triblock copolymer is greater than 90:10, the composition tends to not lift cleanly from the adherent, and can leave unacceptable amounts of residue on the adherent. This can be problematic for certain applications, for example, when the adherent is skin or another biological surface. If the weight ratio of the acrylic diblock copolymer to acrylic triblock copolymer is less than 65:35, then the adhesive composition tends to be too rigid and tends to have insufficient tack for many applications.

The adhesive composition can have low shear. The low shear can be defined quantitatively, for example, as having a particular hold time on stainless steel when a 0.5 inch by 0.5 inch tape is adhered by way of the adhesive composition to stainless steel and a 250 gram weight is attached to the tape. In such cases, an acceptable quantitative shear can be measured by the hold time, that is, time that the adhesive supports the 250 grams mass before failure. Acceptable hold times under such tests can be no more than 3,000 minutes, no more than 2,500 minutes, no more than 2,000 minutes, no more than 1,500 minutes, no more than 1,000 minutes, no more than 750 minutes, no more than 600 minutes, no more than 500 minutes, no more than 400 minutes, no more than 300 minutes, no more than 250 minutes, no more than 200 minutes, no more than 150 minutes, or no more than 100 minutes. Acceptable hold times can also be at least 1 minute, at least 2 minutes, at least 5 minutes, at least 10 minutes, at least 15 minutes, at least 30 minutes, at least 45 minutes, at least 60 minutes, at least 90 minutes, at least 120 minutes, at least 180 minutes, at least 200 minutes, at least 240 minutes, at least 300 minutes, or at least 350 minutes. The low shear can also be defined qualitatively. For example, when the adhesive is used to secure an article to an adherent, the article can be readily removed by hand.

The adhesive composition can further comprise one or more of at least one plasticizer, at least one tackifier, and at least one filler. Plasticizers can include phthalate esters, adipate esters, phosphate esters, citrate esters, sugar derivatives, poly(ethylene glycol), and poly(ethylene glycol) functionalized organic molecules. Exemplary plasticizers include, but are not limited to, one or more of phthalate ester, bis(2-ethylhexyl)adipate, dimethyl adipate, monomethyl adipate, dioxtyl adipate, dibutyl sebacate, dibutyl maleate, biisobutyl maleate, benzoates, terephthalates, 1,2-cyclohexane dicarboxylic acid diisononyl ester, epoxidized vegetable oil, alkyl sulphonic acid phenyl ester, N-ethyl toluene sulfonamide, N-(2-hydroxypropyl)benzene sulfonamide, N-(n-butyl benzene sulfonamide, sucrose acetate isobutyrate, tricresyl phosphate, tributyl phosphate, triethylene glycol dihexanoate, tetraethylene glycol diheptanoate, triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, sucrose acetate isobutyrate, and acetylated monoglyceride.

Tackifiers can include rosins, hydrocarbon resins, terpenes, and MQ silicate resins. Exemplary tackifiers can include one or more of rosin, rosin derivative, terpenes, modified terpenes, C5 aliphatic resins, C9 aromatic resins, C5/C9 aliphatic/aromatic resins, hydrogenated hydrocarbon resin, terpene-phenol resin, poly(alpha-methylstyrene) (AMS) resin, poly(styrene) resins (also known as ‘Pure Monomer Resins), copolymers of (alpha-methylstyrene) and styrene resins, and phenolic modified AMS resins, and MQ silicate resin. Some suitable tackifiers are obtainable under the trade designation KRISTALEX 1120, 3100, 5140 and PLASTOLYN 240, 290 (Eastman Chemical Company), YS RESIN SX 100 (Yasuhara Chemical Co., Ltd., Hiroshima, Japan), NORSOLENE W-100 (Cray Valley Division of Total Petrochemicals and Refining, Inc., Houston, Tex., USA), SYLVARES 520, 525, 540, SA85, SA100, SA120, SA140, TP115P (Arizona Chemical Inc. Jacksonville, Fla., USA), and PICCOPLASTIC A5 Hydrocarbon Resin (Eastman Chemical Company, Kingsport, Tenn., USA).

Fillers can include any appropriate inert inorganic particle. Exemplary fillers include one or more of alumina trihydrate, talc, ceramic, rock, coal, ground glass, glass beads, particulate plastics, non-catalytic metals, sand, silica, calcium carbonate, and magnesium carbonate.

The total amount of plasticizer, tackifier, and filler, if any are included in the composition, can be up to 45% by weight of the adhesive composition, for example, up to 40% by weight of the adhesive composition, up to 35% by weight of the adhesive composition, up to 30% by weight of the adhesive composition, up to 25% by weight of the adhesive composition, up to 20% by weight of the adhesive composition, up to 15% by weight of the adhesive composition, up to 10% by weight of the adhesive composition, up to 5% by weight of the adhesive composition, up to 2% by weight of the adhesive composition, or up to 1% by weight of the adhesive composition. If present, the total amount of plasticizer, tackifier, and filler can be no less than 0.001% by weight, no less than 0.005% by weight, no less than 0.01% by weight, no less than 0.05% by weight, no less than 0.1% by weight, no less than 0.5% by weight, no less than 1% by weight, no less than 1.5% by weight, or no less than 2% by weight of the adhesive composition.

Thus, the components of exemplary adhesive compositions can range in amount from those containing 90% acrylic diblock copolymer, 10% acrylic triblock copolymer, and no tackifier, plasticizer, or filler, to those containing 42.25% acrylic triblock copolymer, 22.75% acrylic diblock copolymer, and 45% of a combination of tackifier, plasticizer, and filler.

An adhesive article can comprise a substrate and an adhesive composition, such as the adhesive compositions disclosed herein. The adhesive is disposed as an adhesive layer adjacent to the substrate. The adhesive layer can be in contact with the substrate or separated from the substrate by another layer such as a primer layer or adhesion promoting layer. The substrate can be any suitable substrate for the adhesive article, for example, a polymeric substrate, a fabric substrate, such as a woven fabric substrate or a non-woven fabric substrate, a cellulose-based substrate, or the like. Typical substrates can include one or more of a polyurethane substrate, a polyethylene substrate, a polyester substrate, a cellulosic substrate, a polyamide substrate, and a poly(ethylene terephthalate) substrate. The adhesive article can further comprise one or more topically administrable pharmaceutically active agents. Exemplary topically administrable pharmaceutically active agents include anti-microbials, anti-fungals, anti-inflammatory agents, including but not limited to steroidal anti-inflammatory agents and non-steroidal anti-inflammatory drugs (NSAIDs), vitamins, beneficial oils, moisturizers, and the like. Specific topically administrable pharmaceutically active agents include iodine, povidone-iodine, silver, salicylic acid or salts thereof, acetylsalicylic acid or salts thereof, chlorhexidine, such as chlorhexidine gluconate, sulfacetamide and salts thereof, erythromycin, neomycin, polymyxin, bacitracin, retapamulin, mupirocin, gentamicin, mefenide, lidocaine, tetracycline, benzoic acid, ciclopirox olamine, undecylenic alkanolamide, bifonazole, clotramazoel, econazole, ketoconazole, miconazole, tioconazole, terbinafine, tolciclate, tolnaftate, tymol, sulfacetamide, almond oil, argan oil, avocado oil, camelina oil, coconut oil, jojoba oil, rose oil, sesame seed oil, shea oil, hemp seed oil, macadamia nut oil, lanolin, vitamins such as vitamin A, vitamin A palmitate, vitamin B3, vitamin C, and tocopherols and esters thereof, such as alpha-tocopherol and alpha-tocopheryl acetate. Such topically administrable pharmaceutically active agents can be used in any suitable amount, such as up to 20% by weight, up to 15% by weight, up to 10% by weight, up to 5% by weight, up to 2% by weight, or up to 1% by weight, based on the total weight of the diblock and triblock copolymers.

An adhesive article containing an adhesive composition as described herein can be used, for example, in medical, veterinary, pharmaceutical, or surgical procedures. For example, an adhesive article can be placed over a wound to treat a wound. The adhesive article can also be placed over a catheter, intravenous needle, or inter-arterial needle that is at least partially inserted into a subject, for example, into a lumen of a subject, in order to stabilize the catheter, intravenous needle, or inter-arterial needle. The adhesive composition can also be used to secure a medical device on or to a subject.

Adhesive articles comprising the adhesive composition described herein can provide low or minimal edge lift over an applicable period of time. An applicable period of time can be, for example, no more than two weeks, no more than twelve days, no more than ten days, no more than one week, no more than five days, no more than three days, or no more than two days. An applicable period of time can also be one day or greater, two days or greater, three days or greater, five days or greater, or one week or greater. Exemplary applicable periods of time include two weeks, twelve days, ten days, one week, five days, three days, two days, or one day. Low or minimal edge lift is particularly useful when the adhesive article is used as a wound dressing, for stabilizing a catheter, intravenous, or inter-arterial needle, or for affixing a medical device.

### EXEMPLARY EMBODIMENTS

Exemplary embodiments of the present disclosure may take on various modifications and alterations without departing from the spirit and scope of the present disclosure. Accordingly, it is to be understood that the particular embodiments described below are not intended to be limiting.

### Embodiment 1

An adhesive composition comprising:
(a) an acrylic triblock copolymer A-B-A comprising from 20% to 55% by weight A blocks and 45% to 80% by weight B block; and
(b) an acrylic diblock copolymer A-B comprising from 5% to 30% by weight A block and 70% to 95% by weight B block, wherein

each A block is independently a polymeric block having a glass transition temperature of at least 50° C.;

each A block independently comprises at least one poly(meth)acrylate;

each B block is independently a polymeric block having a glass transition temperature no greater than 20° C.;

each B block independently comprises at least one poly(meth)acrylate; and

the weight ratio of the acrylic diblock copolymer to the acrylic triblock copolymer is from 65:35 to 90:10.

### Embodiment 2

The adhesive composition of embodiment 1, wherein the acrylic diblock copolymer A block is a homopolymer.

### Embodiment 3

The adhesive composition of any of the preceding embodiments, wherein the acrylic diblock copolymer A block comprises a poly(alkyl (meth)acrylate).

### Embodiment 4

The adhesive composition of embodiment 3, wherein the alkyl (meth)acrylate has a C₁ to C₃ alkyl.

### Embodiment 5

The adhesive composition of embodiment 4, wherein the alkyl is methyl.

### Embodiment 6

The adhesive composition of any of the preceding embodiments, wherein the acrylic diblock copolymer A block comprises poly(alkyl methacrylate).

### Embodiment 7

The adhesive composition of embodiment 6, wherein the poly(alkyl methacrylate) is poly(methyl methacrylate).

### Embodiment 8

The adhesive composition of any of the preceding embodiments, wherein the acrylic diblock copolymer B block is a homopolymer.

### Embodiment 9

The adhesive composition of any of the preceding embodiments, wherein the acrylic diblock copolymer B block comprises poly(alkyl (meth)acrylate).

### Embodiment 10

The adhesive composition of embodiment 9, wherein the alkyl (meth)acrylate has a C₂ to C₁₆ alkyl.

### Embodiment 11

The adhesive composition of embodiment 10, wherein the C₂ to C₁₆ alkyl is C₄ to C₁₂ alkyl.

### Embodiment 12

The adhesive composition of embodiment 11, wherein the C₄ to C₁₂ alkyl is C₄ to C₈ alkyl.

### Embodiment 13

The adhesive composition of embodiment 12, wherein the C₄ to C₈ alkyl alkyl is n-butyl.

### Embodiment 14

The adhesive composition of embodiment 12, wherein the C₄ to C₈ alkyl is 2-ethylhexyl.

### Embodiment 15

The adhesive composition of embodiment 12, wherein the C₄ to C₈ alkyl is isooctyl.

### Embodiment 16

The adhesive composition of any of the preceding embodiments, wherein the acrylic diblock copolymer B block comprises poly(alkyl acrylate).

### Embodiment 17

The adhesive composition of embodiment 16, wherein the poly(alkyl acrylate) is poly(n-butyl acrylate).

### Embodiment 18

The adhesive composition of embodiment 16, wherein the poly(alkyl acrylate) is poly(isooctyl acrylate), poly(2-octyl acrylate), or poly(isononyl acrylate).

### Embodiment 19

The adhesive composition of embodiment 16, wherein the poly(alkyl acrylate) is poly(2-ethylhexyl acrylate).

### Embodiment 20

The adhesive composition of any of the preceding embodiments, wherein at least one of the acrylic triblock copolymer A blocks is a homopolymer.

### Embodiment 21

The adhesive composition any of the preceding embodiments, wherein both of the acrylic triblock copolymer A blocks are homopolymers.

### Embodiment 22

The adhesive composition of any of the preceding embodiments, wherein at least one acrylic triblock copolymer A block comprises poly(alkyl (meth)acrylate).

### Embodiment 23

The adhesive composition of embodiment 22, wherein both acrylic triblock copolymer A blocks comprise poly(alkyl (meth)acrylate).

### Embodiment 24

The adhesive composition of any of embodiments 22-23, wherein the alkyl (meth)acrylate has a C₁ to C₃ alkyl.

### Embodiment 25

The adhesive composition of embodiment 24, wherein the alkyl is methyl.

### Embodiment 26

The adhesive composition of any of the preceding embodiments, wherein both of the acrylic triblock A blocks comprise poly(alkyl methacrylate).

### Embodiment 27

The adhesive composition of embodiment 26, wherein the poly(alkyl methacrylate) is poly(methyl methacrylate).

### Embodiment 28

The adhesive composition of any of the preceding embodiments, wherein the acrylic triblock copolymer B block comprises poly(alkyl (meth)acrylate).

### Embodiment 29

The adhesive composition of embodiment 28, wherein the alkyl (meth)acrylate has a C₂ to C₁₆ alkyl.

### Embodiment 30

The adhesive composition of embodiment 29, wherein the C₂ to C₁₆ alkyl is C₄ to C₁₂ alkyl.

### Embodiment 31

The adhesive composition of embodiment 30, wherein the C₄ to C₁₂ alkyl is C₄ to C₉ alkyl or C₄ to C₈ alkyl.

### Embodiment 32

The adhesive composition of embodiment 31, wherein the C₄ to C₈ alkyl is n-butyl.

### Embodiment 33

The adhesive composition of embodiment 31, wherein the C₄ to C₈ alkyl is 2-ethylhexyl acrylate.

### Embodiment 34

The adhesive composition of embodiment 31, wherein the C₄ to C₉ alkyl is isooctyl acrylate, or isononyl acrylate, or 2-octyl acrylate.

### Embodiment 35

The adhesive composition of any of the preceding embodiments, wherein the acrylic triblock copolymer B block comprises poly(alkyl (meth)acrylate).

### Embodiment 36

The adhesive composition of embodiment 35, wherein the poly(alkyl (meth)acrylate) is poly(n-butyl acrylate).

### Embodiment 37

The adhesive composition of embodiment 35, wherein the poly(alkyl acrylate) is poly(isooctyl acrylate), poly(2-octyl acrylate), or poly(isononyl acrylate).

### Embodiment 38

The adhesive composition of embodiment 35, wherein the poly(alkyl acrylate) is poly(2-ethyl hexyl acrylate).

### Embodiment 39

The adhesive composition of any of the preceding embodiments, wherein the adhesive composition does not contain a chemical crosslinker.

### Embodiment 40

The adhesive composition of any of the preceding embodiments, wherein the weight ratio of the acrylic diblock to the acrylic triblock is from 65:35 to 80:20.

### Embodiment 41

The adhesive composition of any of embodiments 1-39, wherein the weight ratio of the acrylic diblock to the acrylic triblock is from 70:30 to 90:10.

### Embodiment 42

The adhesive composition of any of embodiments 1-39, wherein the weight ratio of the acrylic diblock to the acrylic triblock is from 70:30 to 80:20

### Embodiment 43

The adhesive composition of any of embodiments 1-39, wherein the weight ratio of the acrylic diblock to the acrylic triblock is from 75:25 to 90:10.

### Embodiment 44

The adhesive composition of any of embodiments 1-39, wherein the weight ratio of the acrylic diblock to the acrylic triblock is from 75:25 to 80:20.

### Embodiment 45

The adhesive composition of any of embodiments 1-39, wherein the amount of acrylic diblock copolymer is 65% by weight or greater relative to the total weight of the acrylic diblock and the acrylic triblock.

### Embodiment 46

The adhesive composition of any of embodiments 1-39, wherein the amount of acrylic diblock copolymer is 70% by weight or greater relative to the total weight of the acrylic diblock and the acrylic triblock.

### Embodiment 47

The adhesive composition of any of embodiments 1-39, wherein the amount of acrylic diblock copolymer is 80% by weight or greater relative to the total weight of the acrylic diblock and the acrylic triblock.

### Embodiment 48

The adhesive composition of any of embodiments 1-39, wherein the amount of acrylic diblock copolymer is 85% by weight or greater relative to the total weight of the acrylic diblock and the acrylic triblock.

### Embodiment 49

The adhesive composition of any of embodiments 1-39 or 45-48, wherein the amount of the acrylic diblock is no more than 90% by weight relative to the total weight of the acrylic diblock and the acrylic triblock.

### Embodiment 50

The adhesive composition of embodiment 49, wherein the amount of the acrylic diblock is no more than 85% by weight relative to the total weight of the acrylic diblock and the acrylic triblock.

### Embodiment 51

The adhesive composition of embodiment 50, wherein the amount of the acrylic diblock is no more than 80% by weight relative to the total weight of the acrylic diblock and the acrylic triblock.

### Embodiment 52

The adhesive composition of embodiment 51, wherein the amount of the acrylic diblock is no more than 75% by weight relative to the total weight of the acrylic diblock and the acrylic triblock.

### Embodiment 53

The adhesive composition of embodiment 52, wherein the amount of the acrylic diblock is no more than 70% by weight relative to the total weight of the acrylic diblock and the acrylic triblock.

### Embodiment 54

The adhesive composition of any of embodiments 1-39 or 45-52, wherein the amount of the acrylic triblock is 15% by weight, 20% by weight, or greater relative to the total weight of the acrylic diblock and the acrylic triblock.

### Embodiment 55

The adhesive composition of embodiment 53, wherein the amount of the acrylic triblock is 25% by weight or greater relative to the total weight of the acrylic diblock and the acrylic triblock.

### Embodiment 56

The adhesive composition of any of the preceding embodiments, wherein the amount of the acrylic triblock is no more than 30% by weight relative to the total weight of the acrylic diblock and the acrylic triblock.

### Embodiment 57

The adhesive composition of embodiment 56, wherein the amount of the acrylic triblock is no more than 25% by weight relative to the total weight of the acrylic diblock and the acrylic triblock.

### Embodiment 58

The adhesive composition of embodiment 57, wherein the amount of the acrylic triblock is no more than 20% by weight relative to the total weight of the acrylic diblock and the acrylic triblock.

### Embodiment 59

The adhesive composition of embodiment 58, wherein the amount of the acrylic triblock is no more than 15% by weight relative to the total weight of the acrylic diblock and the acrylic triblock.

### Embodiment 60

The adhesive composition of any of the preceding embodiments, further comprising one or more additives.

### Embodiment 61

The adhesive composition of embodiment 60, wherein the at least one of the one or more additives is compatible with at least one A polymer block, at least one B polymer block, or at least one A polymer block and at least one B polymer block.

### Embodiment 62

The adhesive composition of any of the preceding embodiments, further comprising one or more of at least one plasticizer, at least one tackifier, and at least one filler.

### Embodiment 63

The adhesive composition of any of the preceding embodiments, further comprising at least one plasticizer.

### Embodiment 64

The adhesive composition of embodiment 63, wherein the at least one plasticizer includes one or more of phthalate esters, adipate esters, phosphate esters, citrate esters, sugar derivatives, poly(ethylene glycol), and poly(ethylene glycol) functionalized organic molecules.

### Embodiment 65

The adhesive composition of any of embodiments 63-64, wherein the at least one plasticizer comprises one or more of phthalate ester, bis(2-ethylhexyl)adippate, dimethyl adipate, monomethyl adipate, dioxtyl adipate, dibutyl sebacate, dibutyl maleate, biisobutyl maleate, benzoates, terephthalates, 1,2-cyclohexane dicarboxylic acid diisononyl ester, epoxidized vegetable oil, alkyl sulphonic acid phenyl ester, N-ethyl toluene sulfonamide, N-(2-hydroxypropyl)benzene sulfonamide, N-(n-butyl benzene sulfonamide, sucrose acetate isobutyrate, tricresyl phosphate, tributyl phosphate, triethylene glycol dihexanoate, tetraethylene glycol diheptanoate, triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, and acetylated monoglyceride.

### Embodiment 66

The adhesive composition of any of the preceding embodiments, further comprising at least one tackifier.

### Embodiment 67

The adhesive composition of embodiment 66, wherein the at least one tackifier comprises one or more of rosin, rosin derivative, rosin ester, terpene, modified terpene, C5 aliphatic resin, C9 aromatic resin, C5/C9 aliphatic/aromatic resin, hydrogenated hydrocarbon resin, terpene-phenol resin, poly(alpha-methylstyrene) (AMS) resin, poly(styrene) resins (also known as ‘Pure Monomer Resins), copolymers of (alpha-methylstyrene) and styrene resins, and phenolic modified AMS resins, and MQ silicate resin.

### Embodiment 68

The adhesive composition of any of the preceding embodiments, further comprising at least one filler.

### Embodiment 69

The adhesive composition of embodiment 68, wherein the at least one filler comprises at least one inert inorganic particles and one or more inert polymeric particles.

### Embodiment 70

The adhesive composition of any of embodiments 68-69, wherein the at least one filler comprises one or more of alumina trihidrate, talc, ceramic, rock, coal, ground glass, glass beads, particulate plastics, non-catalytic metals, sand, silica, calcium carbonate, and magnesium carbonate.

### Embodiment 71

The adhesive composition of any of embodiments 62-70, wherein the one or more of at least one plasticizer, at least one tackifier, and at least one filler is present in an amount greater than 0.001% but no greater than 30% by weight of the adhesive composition.

### Embodiment 72

An article comprising:

a substrate; and

the adhesive composition of any of the preceding embodiments disposed adjacent to the substrate.

### Embodiment 73

The article of embodiment 72, wherein the substrate comprises polyurethane.

### Embodiment 74

The article of embodiment 73, wherein the substrate comprises poly(ethylene terephthalate).

### Embodiment 75

A wound dressing comprising the adhesive of any of embodiments 1-71, or the article of any of embodiments 72-74, adapted to adhere to skin.

### Embodiment 76

The adhesive of any of embodiments 1-71, or the article of any of embodiments 72-74, or the wound dressing of embodiment 75, further comprising one or more topically administrable pharmaceutically active agents.

### Embodiment 77

A method of treating a wound, comprising applying the adhesive of any of embodiments 1-71, or the article of any of embodiments 72-74, or the wound dressing of embodiment 75 to the wound.

### Embodiment 78

A method of stabilizing a catheter, comprising:

applying the adhesive of any of embodiments 1-71, or the article of any of embodiments 72-74, or the wound dressing of embodiment 75 over the catheter, wherein the catheter is at least partially inserted into a patient.

### Embodiment 79

A method of stabilizing an intravenous or intra-arterial needle, comprising:

applying the adhesive any of embodiments 1-71, or the article of any of embodiments 72-74, or the wound dressing of embodiment 75 over an intravenous or intra-arterial needle, wherein the intravenous or intra-arterial needle is at least partially inserted into a patient.

### Embodiment 80

A method of affixing a medical device, comprising:

contacting the medical device with an adhesive any of embodiments 1-71, or the article of any of embodiments 72-74, or the wound dressing of embodiment 75; and

affixing the medical device to a subject.

### EXAMPLES

All parts, percentages, ratios, and the like used in the Examples are by weight unless indicated otherwise.

### Materials

| Abbreviation | Description and Source |
|---|---|
| LA2330 | An acrylic triblock copolymer A-B-A, where A is poly(methyl methacrylate) |
| | (“PMMA”) and B is poly(n-butyl acrylate) (“PBA”) with 24 weight % |
| | PMMA, a number average molecular weight of 97.5 kDa, and a weight |
| | average molecular weight of 105.3 kDa as determined by gel permeation |
| | chromatography. Available from Kuraray America Inc., Houston, TX, under |
| | the trade designation “KURARITY LA2330” |
| LA4285 | An acrylic triblock copolymer A-B-A (where A is PMMA and B is PBA) |
| | with 51 weight % PMMA, a number average molecular weight of 48 kDa, |
| | and a weight average molecular weight 57 kDas determined by gel |
| | permeation chromatography. Available from Kuraray America, Inc., |
| | Houston, TX, under the trade designation “KURARITY LA4285” |
| LA2140 | An acrylic triblock copolymer A-B-A where A is PMMA and B is PBA with |
| | 24 weight % PMMA, a number average molecular weight of 60 kDa, and a |
| | weight average molecular weight of 66 kDa as determined by gel permeation |
| | chromatography. Available from Kuraray America Inc. Houston, TX, under |
| | the trade designation “KURARITY LA2140” |
| LA1114 | An acrylic diblock copolymer A-B where A is PMMA and B is PBA with 7 |
| | weight % PMMA, a number average molecular weight of 50 kDa, and a |
| | weight average molecular weight of 60 kDa as determined by gel permeation |
| | chromatography. Available from Kuraray America Inc., Houston, TX, under |
| | the trade designation “KURARITY LA1114” |
| Toluene | Toluene, available from Avantor Performance Materials, Center Valley, PA |
| YS RESIN SX100 | A pure styrene resin tackifying resin, available from Yasuhara Chemical, |
| | Hiroshima, JP, under the trade designation “YS RESIN SX100” |
| SYLVALITE | A rosin ester tackifier, available from Arizona Chemical, Jacksonville, FL, |
| RE80HP | under the trade designation “SYLVALITE RE80HP” |
| SAIB | Sucrose acetate isobutyrate, a plasticizer available from Eastman Chemical |
| | Company, Kingsport, TN |
| ESTANE 58309 | Thermoplastic polyurethane elastomer available in pellet form from Lubrizol |
| | Advanced Materials, Inc., Cleveland, OH, under the trade designation |
| | “ESTANE 58309” |
| 3SAB PRIMED | 50 micrometer thick primed polyester film, available from Mitsubishi |
| PET | Polyester Film, Greer, South Carolina, under the trade designation “3SAB |
| FILM | PRIMED PET FILM” |

### Sample Preparation Method: Coated Adhesive Tapes (Examples and Comparative Examples)

Acrylic block copolymer blends were combined with any tackifiers and other additives being used for the particular experiment. The block copolymers (and tackifier or other additive, if included) were combined in the amounts specified in Table 1 to Table 6, below. The resulting compositions were dissolved in toluene to form 50 weight percent solids solutions, and these solutions were knife coated on a siliconized paper release liner. The coatings were dried in an oven at 70° C. for 10 minutes. The final thickness of the layer of dried adhesive was nominally 38 micrometers.

Laminated samples for the 180° Peel Adhesion Test (see below) and the Shear Strength Test (see below) were prepared by laminating a 50 micrometer poly(ethylene terephthalate) film (i.e., 3SAB PRIMED PET FILM) to the layer of dried adhesive.

Laminated samples for the Adhesion to Skin Test (see below) were prepared by laminating the dried adhesive prepared for the 180° Peel Adhesion Test to a 20 micrometer thick polyurethane film. The polyureathane film was prepared by extrusion coating ESTANE 58309 (Lubrizol, Wickliffe, Ohio) onto a polycoated-paper carrier for support.

All sample tapes were conditioned in a constant temperature (25° C.) and humidity room (50% relative humidity) for at least 24 hours before testing.

### Test Methods

### 180° Peel Adhesion Test

The 180° peel adhesion test was similar to the test method described in ASTM D3330 Method E. The adhesive coatings were laminated to 3SAB PRIMED PET FILM, as described in the above Sample Preparation Method. Tapes 1 inch (˜2.5 cm) wide were cut from the laminated samples. Stainless steel testing substrates were cleaned with reagent grade n-heptane followed by methyl ethyl ketone and clean lint-free absorbent tissue. The release liner was removed and the tape was rolled down onto a stainless steel plate with a 4.5 lb (˜2 kg) roller. The sample was allowed to dwell for one minute before peeling at 12 inches (˜30 cm) per minute using an IMASS 2000 slip/peel tester (available from Instrumentors, Inc., Strongsville, Ohio). For each adhesive composition, two sample tapes were tested, and the reported peel adhesion value was an average of the peel adhesion value for each of the two sample tapes.

### Shear Strength Test

The shear strength test was similar to the test method described in ASTM D3654 Method A. The adhesive coatings were laminated to 3SAB PRIMED PET FILM, as described in the above Sample Preparation Method. Tapes 0.5 inch (˜1.3 cm) wide were cut from the laminated samples. The tape sample was rolled down onto a cleaned stainless steel panel using a 4.5 lb (˜2 kg) roller. A hook was attached to the unsupported end of the tape and the sample adhered to the panel was trimmed to 0.5 inch (˜1.3 cm) by 0.5 inch (˜1.3 cm). The sample was allowed to dwell for one minute prior the test panel being placed on the test stand. A 250 gram mass was applied to the hook. The time to failure of the sample was measured in triplicate and reported as an arithmetic mean in minutes.

### Adhesion to Skin Test

The adhesive coatings were laminated to a 20 micrometer thick polyurethane film, prepared from ESTANE 58309, as described in the above Preparation Method. Tapes 2.5 cm by 7.5 cm were cut from the laminated samples. The release liner was removed from the sample tape strip and the exposed adhesive was placed against the distal forearm of a healthy human volunteer. Tape strips were rolled down with a 4.5 lb (˜2 kg) roller. Visual assessments of a sample tape edge lift were recorded after 48 hours of wear. Visual assessment criteria used to score the tape edge lift was as follows:

Tape Edge Lift:

0=No sample area has lifted from the skin

1=>1-25% of the sample area has lifted from the skin

2=26-50% of the sample area has lifted from the skin

3=51-75% of the sample area has lifted from the skin

4=76-99% of the sample area has lifted from the skin

5=100% of the sample has lifted from the skin (i.e., the sample has fallen off)

After 48 hours of dwell time, the samples were peeled from the skin at 180° at approximately 90 inches (about 230 cm) per minute peel rate. The presence of residue was noted using the following visual assessment scale:

Residue:

0=0% of area under the sample has left residue on skin

1=1-25% of area under the sample has left residue on skin

2=26-50% of area under the sample has left residue on skin

3=51-75% of area under the sample has left residue on skin

4=76-100% of area under the sample has left residue on skin

Examples EX-1 to EX-4 and Comparative Examples CE-1 to CE-3 had the compositions and test results as summarized in Table 1.

TABLE 1

| | | | Adhesion and Shear | | Adhesion to Skin | |
|---|---|---|---|---|---|---|
| | Acrylic | | on Steel | | Test | |
| | copolymer, | | 180° Peel | Shear | Tape | |
| | weight ratio | | Adhesion | Strength | Edge | |
| Sample | LA2330 | LA1114 | (g/cm) | (min) | Lift | Residue |
| EX-1 | 0.3 | 0.7 | 127 | 2126 | 2 | 0 |
| EX-2 | 0.2 | 0.8 | 202 | 463 | 2 | 0 |
| EX-3 | 0.15 | 0.85 | 301 | 258 | 0 | 1 |
| EX-4 | 0.1 | 0.9 | 208 | 15 | 0 | 2 |
| CE-1 | 0.5 | 0.5 | 239 | 4814 | 5 | 0 |
| CE-2 | 0.4 | 0.6 | 300 | 1816 | 5 | 0 |
| CE-3 | 0.05 | 0.95 | 286 | 4 | 0 | 4 |

Examples EX-5 to EX-13 and Comparative Examples CE-4 to CE-7 included a rosin ester tackifier additive (in parts per hundred (“pph”) relative to the 100 parts acrylic block copolymer), with compositions and test data as summarized in Table 2.

TABLE 2

| | | | | Adhesion | | | |
|---|---|---|---|---|---|---|---|
| | | | | and Shear | | | |
| | | | | on Steel | | | |
| | | | | 180° | | | |
| | | | Rosin | Peel | | | |
| | | | Ester | Ad- | | Adhesion to | |
| | Acrylic | | Tackifier, | he- | | Skin Test | |
| | copolymer, | | pph | sion | Shear | Tape | |
| | weight ratio | | SYLVILITE | (g/ | Strength | Edge | Res- |
| Sample | LA2330 | LA1114 | RE80HP | cm) | (min) | Lift | idue |
| EX-5 | 0.3 | 0.7 | 11.1 | 246 | 1094 | 2 | 0 |
| EX-6 | 0.2 | 0.8 | 11.1 | 318 | 276 | 0 | 0 |
| EX-7 | 0.1 | 0.90 | 11.1 | 227 | 19 | 0 | 2 |
| EX-8 | 0.3 | 0.7 | 25 | 329 | 1387 | 2 | 0 |
| EX-9 | 0.2 | 0.8 | 25 | 524 | 609 | 1 | 0 |
| EX-10 | 0.1 | 0.90 | 25 | 302 | 22 | 0 | 2 |
| EX-11 | 0.35 | 0.65 | 42.9 | 560 | 1200 | 1 | 0 |
| EX-12 | 0.21 | 0.79 | 42.9 | 495 | 500 | 0 | 0 |
| EX-13 | 0.14 | 0.86 | 42.9 | 515 | 175 | 0 | 0 |
| CE-4 | 0.5 | 0.5 | 11.1 | 185 | 1199 | 5 | 0 |
| CE-5 | 0.4 | 0.6 | 11.1 | 269 | 2177 | 5 | 0 |
| CE-6 | 0.5 | 0.5 | 25 | 262 | 10000 | 5 | 0 |
| CE-7 | 0.4 | 0.6 | 25 | 334 | 3386 | 5 | 0 |

Examples EX-14 to EX-21 and Comparative Examples CE-8 to CE-14 included a plasticizer additive, with compositions and test data as summarized in Table 3.

TABLE 3

| | | | | Adhesion and Shear | | Adhesion | |
|---|---|---|---|---|---|---|---|
| | | | | on Steel | | to Skin | |
| | Acrylic | | Plasti- | 180° | | Test | |
| | copolymer, | | cizer, | Peel | Shear | Tape | |
| | weight ratio | | pph | Adhesion | Strength | Edge | Res- |
| Sample | LA2330 | LA1114 | SAIB | (g/cm) | (min) | Lift | idue |
| EX-14 | 0.3 | 0.7 | 11.1 | 325 | 211 | 2 | 0 |
| EX-15 | 0.2 | 0.8 | 11.1 | 555 | 245 | 0 | 0 |
| EX-16 | 0.13 | 0.87 | 11.1 | 631 | 54 | 1 | 1 |
| EX-17 | 0.1 | 0.90 | 11.1 | 504 | 7 | 0 | 2 |
| EX-18 | 0.3 | 0.7 | 25 | 633 | 238 | 1 | 0 |
| EX-19 | 0.2 | 0.8 | 25 | 1010 | 104 | 0 | 0 |
| EX-20 | 0.1 | 0.90 | 25 | 580 | 1 | 0 | 2 |
| EX-21 | 0.35 | 0.65 | 42.9 | 652 | 265 | 1 | 0 |
| CE-8 | 0.4 | 0.6 | 11.1 | 695 | 2000 | 3 | 0 |
| CE-9 | 0.05 | 0.95 | 11.1 | 256 | 2 | 0 | 4 |
| CE-10 | 0.5 | 0.5 | 25 | 626 | 2306 | 5 | 0 |
| CE-11 | 0.4 | 0.6 | 25 | 665 | 3035 | 3 | 0 |
| CE-12 | 1 | 0 | 42.9 | 338 | 10000 | 5 | 0 |
| CE-13 | 0.71 | 0.29 | 42.9 | 674 | 854 | 5 | 0 |
| CE-14 | 0.5 | 0.5 | 42.9 | 681 | 527 | 2 | 0 |

Examples EX-22 to EX-26 and Comparative Examples CE-15 to CE-16 included a tackifier resin additive, with compositions and test data as summarized in Table 4.

TABLE 4

| | | | | Adhesion and | | | |
|---|---|---|---|---|---|---|---|
| | | | Tackifier | Shear on Steel | | | |
| | | | Resin, | 180° | | Adhesion to | |
| | Acrylic | | pph | Peel | | Skin Test | |
| | copolymer, | | YS | Ad- | Shear | Tape | |
| | weight ratio | | RESIN | hesion | Strength | Edge | Resi- |
| Sample | LA2330 | LA1114 | SX100 | (g/cm) | (min) | Lift | due |
| EX-22 | 0.28 | 0.72 | 11.1 | 688 | 986 | 1 | 0 |
| EX-23 | 0.22 | 0.78 | 11.1 | 858 | 416 | 0 | 0 |
| EX-24 | 0.25 | 0.75 | 25.0 | 967 | 992 | 0 | 0 |
| EX-25 | 0.15 | 0.85 | 17.0 | 911 | 758 | 0 | 0 |
| EX-26 | 0.1 | 0.9 | 17.6 | 955 | 275 | 0 | 2 |
| CE-15 | 0.36 | 0.64 | 17.6 | 951 | 4557 | 3 | 0 |
| CE-16 | 0.47 | 0.53 | 17.6 | 807 | 6842 | 5 | 0 |

Examples EX-27 to EX-29 had the compositions and test results as summarized in Table 5.

TABLE 5

| | | | Adhesion and Shear | | | |
|---|---|---|---|---|---|---|
| | | | on Steel | | Adhesion to | |
| | | | 180° | | Skin Test | |
| | Acrylic copolymer, | | Peel | Shear | Tape | |
| | weight ratio | | Adhesion | Strength | Edge | |
| Sample | LA4285 | LA1114 | (g/cm) | (min) | Lift | Residue |
| EX-27 | 0.20 | 0.80 | 171 | 7 | 0 | 0 |
| EX-28 | 0.15 | 0.85 | 144 | 1 | 0 | 1 |
| EX-29 | 0.1 | 0.90 | 157 | 6 | 0 | 1 |

Examples EX-30 to EX-33 had the compositions and test results as summarized in Table 6.

TABLE 6

| | | | Adhesion and | | Adhesion to Skin | |
|---|---|---|---|---|---|---|
| | | | Shear on Steel | | Test | |
| | Acrylic copolymer, | | 180° Peel | Shear | Tape | |
| | weight ratio | | Adhesion | Strength | Edge | |
| Sample | LA2140 | LA1114 | (g/cm) | (min) | Lift | Residue |
| EX-30 | 0.3 | 0.7 | 249 | 1846 | 1 | 0 |
| EX-31 | 0.2 | 0.8 | 355 | 294 | 1 | 0 |
| EX-32 | 0.15 | 0.85 | 573 | 248 | 0 | 0 |
| EX-33 | 0.1 | 0.9 | 442 | 54 | 0 | 1 |

As shown in the above tables, samples having acrylic diblock and acrylic triblock copolymers with the relative amounts of A and B blocks described herein, wherein the diblock and triblock copolymers are present in the ratios described herein, have superior peel and shear properties. Such polymers also have better results in edge lift and residue tests when applied to human skin. In particular, such samples have acceptable values for all of these parameters. By comparison, the Comparative Examples give unacceptable results with respect to at least one of these parameters. For instance, despite having a higher adhesion than Example 1, Comparative Example 1 has an unacceptable edge lift. Also, while Example 14 has acceptably low shear and edge lift, Comparative Example 8, which differs from Example 14 only in that it features a ratio of acrylic diblock to triblock copolymers that is slightly outside of the requisite range, has a sheer that is nearly 100 times that of Example 8 as well as an unacceptably high edge lift. Thus, adhesives having the combination of acrylic diblock and triblock copolymers as described herein surprisingly provide an acceptable balance of all of these parameters.

While the specification has described particular embodiments in detail to assist the artisan's understanding, those skilled in the art will readily conceive of various alternatives, variations, and equivalents of the description. It should therefore be understood the protection sought is to be limited only by the appended claims and not by the particular embodiments and discussed herein.

1. An adhesive composition comprising:
an acrylic triblock copolymer A-B-A comprising from 20% to 55% by weight of A blocks and 45% to 80% by weight of B block; and
an acrylic diblock copolymer A-B comprising from 5% to 30% by weight of A block and 70% to 95% by weight of B block, wherein
each A is independently a polymeric block having a glass transition temperature of at least 50° C.; and
each A independently comprises at least one poly(meth)acrylate; and
each B is independently a polymeric block having a glass transition temperature no greater than 20° C. and;
each B independently comprises at least one poly(meth)acrylate; and
the weight ratio of the acrylic diblock copolymer to the acrylic triblock copolymer is from 70:30 to 90:10.

2. The adhesive composition of claim 1, wherein the acrylic diblock copolymer A block comprises poly(alkyl (meth)acrylate).

3. The adhesive composition of claim 2, wherein the poly(alkyl (meth)acrylate) is poly(methyl methacrylate).

4. The adhesive composition of claim 1, wherein the acrylic diblock copolymer B block comprises poly(alkyl (meth)acrylate).

5. The adhesive composition of claim 4, wherein the alkyl (meth)acrylate has a C₄ to C₉ alkyl or a C₄ alkyl to C₈ alkyl.

6. The adhesive composition of claim 5, wherein the poly(alkyl (meth)acrylate) is poly(n-butyl acrylate), poly(isooctyl acrylate), poly(2-octyl acrylate), poly(isononyl acrylate), or poly(2-ethyl hexyl acrylate).

7. The adhesive composition of claim 1, wherein at least one of the acrylic triblock copolymer A blocks comprises poly(alkyl (meth)acrylate).

8. The adhesive composition of claim 1, wherein both of the acrylic triblock copolymer A blocks comprise poly(alkyl (meth)acrylate).

9. The adhesive composition of claim 7, wherein the poly(alkyl (meth)acrylate) is poly(methyl methacrylate).

10. The adhesive composition of claim 1, wherein the acrylic triblock copolymer B block comprises poly(alkyl (meth)acrylate).

11. The adhesive composition of claim 10, wherein the poly(alkyl (meth)acrylate) has a C₄ alkyl to C₉ alkyl or a C₄ alkyl to C₈ alkyl.

12. The adhesive composition of claim 11, wherein the poly(alkyl (meth)acrylate) is poly(n-butyl acrylate), poly(isooctyl acrylate), poly(2-octyl acrylate), poly(isononyl acrylate), or poly(2-ethyl hexyl acrylate).

13. The adhesive composition of claim 1, further comprising a tackifier.

14. An article comprising:
a substrate; and
an adhesive layer disposed adjacent to the substrate, wherein the adhesive layer comprises the adhesive composition of claim 1.

15. The article of claim 14, wherein the adhesive layer has a first surface that is attached to the substrate and a second opposite surface that is attached to a biological surface.
